(19) United States
(12) Patent Application Publication
(10) Pub. No.: US 2005/0195928 A1
(43) Pub. Date: Sep. 8, 2005

(54) Transmission apparatus

(75) Inventor: Manabu Yamazaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/041,432

(22) Filed: Jan. 25, 2005

(30) Foreign Application Priority Data
Feb. 25, 2004 (JP) 2004-050071 (PAT.

(51) Int. Cl. H04L 7/00

(52) U.S. Cl. 375/354

(57) ABSTRACT

During detection of an amount for deskew, a test signal generator generates a test signal that has an edge, and a transmitter transmits the test signal. A reflected wave detection circuit detects a reflected wave of the test signal. A time measurement circuit measures the time from the instant the test signal is generated to the instant the reflected wave is detected. Data representing the measured time is transferred to an adjustment circuit, whereby an amount for deskew is calculated. During normal operation, a skew adjustment circuit transmits a signal, which is skew-adjusted according to the amount for deskew sent from the adjustment circuit, to the transmitter.

### BACKGROUND OF THE INVENTION

1. Field of the Invention

The present invention relates to transmission apparatus including a plurality of transmission lines and capable of adjusting a signal for skew.

2. Description of the Related Art

In recent years, data communication technology has been applied to the fields of automobiles and home electronic appliances. Further, information processing equipment and communication equipment adopt a frequency band range from megahertz to gigahertz. For data communication, if one data line or a pair of data lines cannot cover a desired frequency band, a plurality of data lines or a plurality of pairs of data lines is employed. Variations of signals must not exist among the data lines or the pairs of data lines. However, the properties of circuits, for example, LSIs varies, and the length of a transmission line or wiring in an LSI package differs with each LSI package. The length of wiring leading to a backplane connector or a cable connector on a printed-circuit board, on which LSIs are mounted, differs with each printed-circuit board. The length of wiring in the backplane connector or cable connector varies with each backplane connector or cable connector. The variations and differences cause a time difference or a phase difference (skew) between signals. As the transmission rate of a signal increases, a small skew poses a problem. Very strict restrictions are therefore in place at present.

For example, according to recent standards such as PCI Express and InfiniBand, the maximum transmission speed of a signal is 2.5 Gbps, that is, 400 ps per bit. The velocity of propagation of electricity on a printed circuit board (FR4 laminate) normally ranges from 6 ns/m to 7 ns/m. If the lengths of transmission lines have a difference of 50 mm, a skew (time lag) of one signal from the other is approximately 350 ps and nearly equivalent to one bit.

Conventional methods or systems for adjusting a signal against a skew will be described below.

(1) According to one method, a skew of data received by a receiver on each path or lane from corresponding data is reduced by performing layout so that the lengths of transmission lines will be exactly equal to one another. In this case, the length of a transmission line comprising, for example, an LSI package, a printed circuit board, a connector, and a cable must be the same among all paths. As the number of paths increases or as the form of a transmission line becomes complex, the labor and time is required for the work of making the lengths of transmission lines equal each to one another. Moreover, as the transmission rate of a signal becomes higher, the difference between transmission lines must be smaller. This leads to an increase in the required labor and time.

(2) According to another method, a receiver includes a register in which a received signal is temporarily preserved. When data items passed along different paths are all received, the data items are transferred to a succeeding processing circuit. In this case, as the difference between the lengths of transmission lines gets larger, or as the transmission speed of a signal gets higher, the number of required registers increases.

(3) According to another technique, the phase of each signal is adjusted according to a delay time caused by a transmission line before the signal is transmitted. The signal is thus deskewed. Specifically, each signal is transmitted on each plurality of transmission lines while being delayed by a time equivalent to a skew, which is caused by each transmission line, so that the times required for the signal to propagate over the transmission lines will be equal to one another. This technique does not need the design of complex wiring in a receiving side, a large-scale register, or control of communications in a sophisticated manner.

Referring to FIG. 11, the deskewing technique of the above item (3) will be described below. FIG. 11 schematically shows data transmission apparatus having a plurality of ports, that is, a plurality of transmission lines (for example, cables and wiring to a printer). Circuit blocks 120, 121, 122, . . . included in respective ports are associated with respective transmission lines. The circuit blocks 121 . . . have the same configuration as the circuit block 120.

The circuit block 120 comprises a transmitter 101, a transmission line 103, and a receiver 102. During normal operation, a skew adjustment circuit 109 transmits a skew-adjusted data. Further, the circuit block 120 comprises a test data pattern generator 104 that generates a test data pattern to detect a skew. In order to determine an amount for deskew to be used by the skew adjustment circuit 109, the test data pattern generator 104 transmits a test data pattern to detect a skew. The amount for deskew is calculated on the basis of the detected skew.

The test data sent from the transmitter 101 is propagated to the receiver 102 over the transmission line 103. The data is transferred to a test data pattern detection circuit 105 included in the receiver 102. The test data pattern detection circuit 105 detects reception of the test data pattern, and then informs a notification circuit 106 of the fact. The notification circuit 106 notifies a time measurement circuit 108 of the reception of the test data pattern over a transmission line 107. The time measurement circuit 108 measures a time difference between the timing that the test data pattern generator 104 generates and transmits the test data pattern and the timing that the notification circuit 106 notifies to the reception of the test data pattern. The time measurement circuit 108 then transmits the time difference information to an adjustment circuit 110. The adjustment circuit 110 calculates each amount, for deskew, which will cancel out a skew of data received by the receiver included in each circuit block, on the basis of the time difference information sent from the time measurement circuit 108 and pieces of time difference information sent from the other circuit blocks 121, 122 . . . The adjustment circuit 110 then transmits amount information for deskew to the skew adjustment circuit 109 included in each circuit block. Based on the amount information for deskew sent from the adjustment circuit 110, the skew adjustment circuit 109 skews data, which is handled during normal operation, to transfer the skew adjusted data to the transmitter 101.

Amount information for deskew is transferred to the skew adjustment circuits included in the circuit block 121 and others in the same manner as it is to the skew adjustment circuit in the circuit block 120. Consequently, during normal operation, the receivers in the circuit blocks can receive data without a skew.

As mentioned above, conventionally, the transmitter transmits a test data pattern to detect a skew and the receiver receives it. The transmitter is notified of the reception over a dedicated signal line. A time difference occurring in each port is measured. Thereafter, the transmitter skews the transmission signal corresponding to the time difference. Thus, signals in ports are deskewed (refer to Japanese Unexamined Patent Application Publication No. 11-275066).

However, the foregoing conventional technique requires transmission of a test data pattern for detection of a skew. Moreover, since data is normally transmitted in the form of a data stream including a command, an address, and data, a dedicated data stream must be defined as the test data pattern.

Furthermore, the receiving side must include the test data pattern detection circuit, the notification circuit that notifies the transmitting side of detection, and the transmission line over which a notification is transferred. Accordingly, the control sequence becomes complex, and the layout of circuit elements, and transmission lines, becomes complex.

### SUMMARY OF THE INVENTION

An object of the present invention is to provide transmission apparatus that performs skew adjustment using a simple configuration according to a simple control sequence.

In order to solve the aforesaid problems, the present invention provides transmission apparatus comprising a plurality of circuit blocks each of which includes a skew adjustment circuit, a transmitter, a transmission line, and a receiver. The circuit block comprises a test signal generator that generates a test signal which has an edge and transfers the signal to the transmitter, a reflected wave detection circuit that detects a reflected wave of the test signal, and a time measurement circuit that measures a time from the instant the test signal was generated to the instant the reflected wave is detected. Thus, data to be transmitted is skew-adjusted on the basis of the measured time data.

Moreover, the transmission apparatus in accordance with the present invention may include a high-impedance signal generator that generates a high-impedance signal which brings the receiver into a high-impedance mode. The signal generated by the test signal generator and having an edge may be a single pulse.

Furthermore, the reflected wave detection circuit may detect a reflected wave on the basis of a voltage change at the transmission terminal of the transmitter. Moreover, a dummy signal generator that generates a dummy signal which correlates at least with the test signal may be included. A difference from a detected reflected wave to the dummy signal may be detected in order to detect the reflected wave.

A test signal employed in the present invention does not require a data pattern unlike the one employed conventionally. The test signal can merely have an edge rising from a low level to a high level. This leads to simple circuitry.

Moreover, as the conventional test data pattern is returned from the receiver over a different transmission line, a skew caused by the transmission line itself cannot be measured accurately. According to the present invention, a reflected wave returned over the same transmission line as the transmission line over which an original signal is transmitted is detected. Consequently, a skew caused by the transmission line can be measured accurately.

According to one aspect of the present invention, the receiver offers a high impedance at an terminal thereof so as to actively induce reflection. Therefore, a reflected wave can be readily detected.

According to another aspect of the present invention, the reflected wave detection circuit includes the dummy signal generator. Therefore, the efficiency in detecting a reflected wave improves.

### BRIEF DESCRIPTION OF THE DRAWINGS

FIG. 1 shows an embodiment of a transmission apparatus in accordance with the present invention;

FIG. 2 shows a skew adjustment circuit included in the transmission apparatus in accordance with the present invention;

FIG. 3 shows a truth table employed by a selector circuit included in the skew adjustment circuit shown in FIG. 2;

FIG. 4 shows another example of the embodiment of the transmission apparatus in accordance with the present invention;

FIG. 5 shows a time measurement circuit included in the embodiment of the present invention;

FIG. 6 is a timing chart showing the timings of actions to be performed by the time measurement circuit shown in FIG. 5;

FIG. 7 shows a reflected wave detection circuit included in the embodiment of the present invention;

FIG. 8 is a timing chart showing the timings of actions to be performed by the reflected wave detection circuit shown in FIG. 7;

FIG. 9 is a flowchart (part 1) describing actions to be performed in the embodiment of the present invention;

FIG. 10 is a flowchart (part 2) describing actions to be performed in the embodiment of the present invention; and

FIG. 11 shows conventional transmission apparatus capable of adjusting data against a skew.

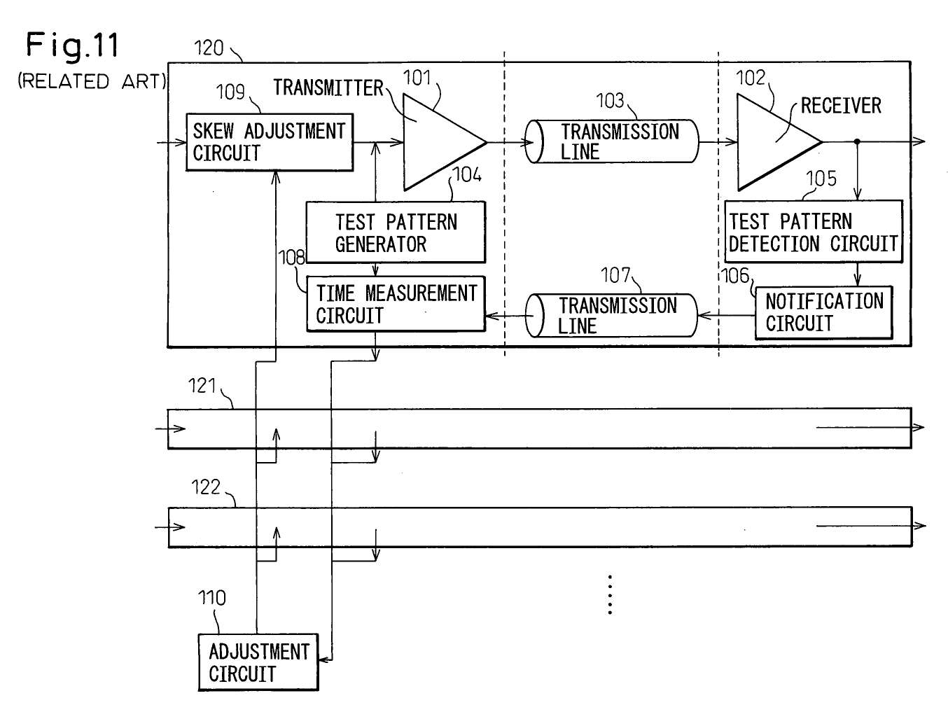

### DESCRIPTION OF THE PREFERRED EMBODIMENTS

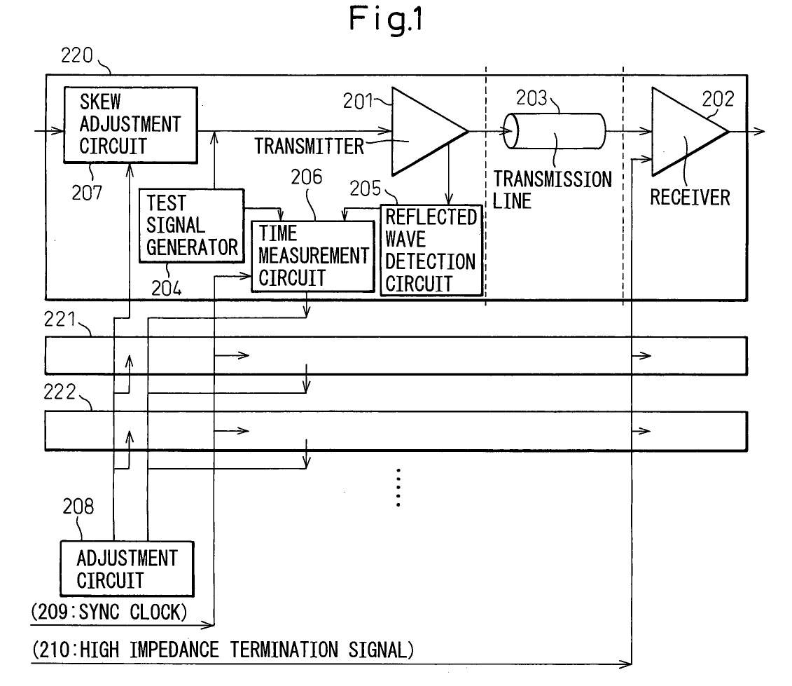

Referring to the drawings, an embodiment will be described below. FIG. 1 shows transmission apparatus in accordance with an embodiment of the present invention. Circuit blocks 220, 221, 222, . . . constitute the transmission apparatus and share the same internal configuration.

A transmitter 201 normally transmits a data signal that is deskewed by a skew adjustment circuit 207. A receiver 202 receives the data signal, which is transmitted from the transmitter 201, over a transmission line 203. The transmission line 203 is arranged to, for example, an LSI package on a printed-circuit board. Further, the line 203 is composed of a connector or a cable. The data signal sent from the transmitter 201 is propagated to the receiver 202 over the transmission line 203.

A skew adjustment circuit 207 delays input data, which has not been skew-adjusted, by a predetermined time according to amount information, for deskew, sent from an adjustment circuit 208. The skew adjustment circuit 207 thus generates data 433 that has been skew-adjusted.

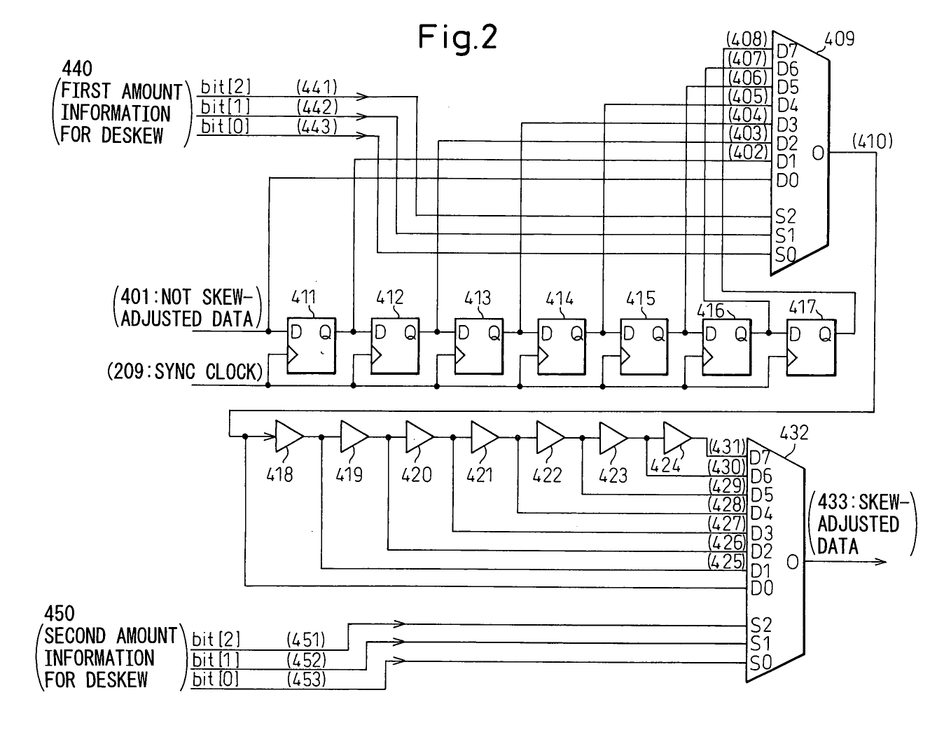

The internal configuration of the skew adjustment circuit to be used for normal transmission will be described below. FIG. 2 shows the skew adjustment circuit 207 included in the embodiment of the present invention. The skew adjustment circuit 207 receives data 401, which has not been skew-adjusted and is about to be transmitted, a synchronizing (sync) clock 209, and pieces of first and second amount information for deskew 440 and 450, and transmits data 433 having been skew-adjusted.

First, the data 401 that has not been skew-adjusted is applied to a terminal D of a synchronous delay circuit composed of D flip-flops (DFF) 411 to 417. The sync clock 209 is applied to a clock terminal of each of the DFFs. Every time the sync clock 209 is applied to the clock terminal, the data is shifted to an output-side DFF. Namely, the DFFs 411 to 417 delay the data 401 in units of the cycle of the sync clock 209. The outputs of the DFFs 411 to 417 are handled as input data items 402 to 408 that are applied to the respective input terminals D1 to D7 of a first selector 409. The data items are produced by delaying the data 401, which has not been skew-adjusted, in units of the cycle of the sync clock. The data 401 that has not been delayed is applied to the input terminal D0 of the selector 409.

The first amount information for deskew 440 sent from the adjustment circuit 208 (three-bit information comprising the highest-order bit 441, the second highest-order bit 442, and a bit 443) is applied to the input terminals S0 to S3 of the selector 409. The selector 409 transmits as an output signal 410 one of the data items 401 to 408, which are applied to the input terminals D0 to D7 thereof, via an output terminal O thereof.

The output signal 410 of the first selector 409 is transmitted to buffers 418 to 424 that are connected in series with one another. The buffers transmit output signals 425 to 431 at intervals of a time equivalent to a one-eighth of the cycle of the sync clock 209. The signals 425 to 431 are applied to input terminals D1 to D7 of a second selector 432. The output signal 410 is applied to an input terminal D0. The selector circuit 432 transmits one of the data items 425 to 431, which are applied to the input terminals D0 to D7, to an output terminal O according to the bits 451 to 453 of the second amount information for deskew 450. The output signal is data 433 having been skew-adjusted.

Namely, the input data 401 is delayed by a time calculated according to “the time equivalent to the cycle of the sync clock 209×the first amount information for deskew+the time equivalent to a one-eighth of the cycle of the sync clock 209×the second amount information for deskew.” Consequently, the data 433 having been delayed by the time equivalent to a predetermined skew is generated.

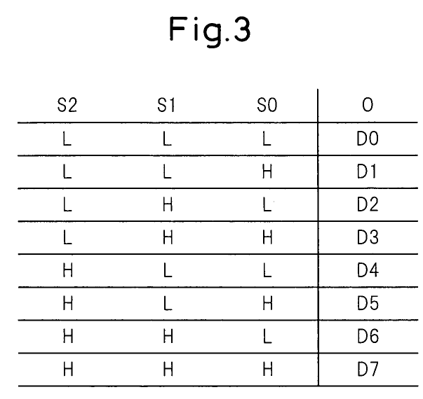

FIG. 3 is a truth table listing logical operations to be performed by the first and second selectors 409 and 432. Depending on the first and second amount information for deskew whose three bits are applied to the terminals S2, S1, and S0 respectively, one of input signals applied to the input terminals D0 to D7 of the selector circuit 409 or 432 is transmitted as the output data 410 or 433.

The skew adjustment circuit acts as mentioned above. Normally, a signal having been skew-adjusted is transmitted. Thus, the signal is adjusted so that it will be received at a time instant having no difference from time instants at which all the other signals transmitted in parallel with one another are received. Referring back to FIG. 1, detection of amount for deskew to be performed will be described below. In order to detect a skew or amount for deskew, a test signal sent from the test signal generator 204 is transferred to the transmitter 201.

According to the present invention, the test signal sent from the test signal generator 204 can be a signal or data having at least an edge, for example, a signal having only one edge (making a transition from logical 0 to 1 or from logical 1 to 0) or a pulse having edges (making a transition from logical 0 to 1 and from logical 1 to 0 or making a transition from logical 1 to 0 and from logical 0 to 1). In this example, a signal having an edge that makes a transition from logical 0 to logical 1 is regarded as the test signal. The test signal generator 20 transfers the test signal to the transmitter, and also transfers a test signal generation flag, which indicates generation of the test signal, to the time measurement circuit 206. The time measurement circuit 206 references the test signal generation flag so as to start measurement of a time.

During normal operation, the impedances offered by the transmitter, transmission line, and receiver are matched with one another or are set to, for example, 50 Q. During detection of the amount for deskew, a high-impedance termination signal 210 is transferred from a high-impedance termination signal generator (not shown) to the receiver 202 in order to give a high terminal resistance at the receiving terminal of the receiver 202. Thus, the receiver 202 is set to a high input-impedance mode, that is, changed into the mode in which a reflected wave is actively generated. Consequently, a test signal having reached the receiver 202 is certainly reflected from the receiving terminal of the receiver 202, and returned to the transmitter 201 over the same transmission line 203 over which it is transferred.

A reflected wave detection circuit 205 is connected to the transmission terminal of the transmitter 201. The reflected wave detection circuit 205 detects a reflected wave of the test signal sent from the transmitter 201, and informs the time measurement circuit 206 of the fact that it has detected the reflected wave. The time measurement circuit 206 measures the time from the instant the test signal generator 204 generates the test signal to the instant the reflected wave detection circuit 205 detects the reflected wave. The time measurement circuit 108 informs an adjustment circuit 208 of information on the required time (for example, the measured time required for a signal to travel and return along the transmission line, or a half of the time, that is, the time required for the signal to travel along the transmission line). The adjustment circuit 208 determines an amount for deskew on the basis of the information sent from the time measurement circuit 208, and transfers the amount for deskew as a first and second amount information for deskew to the skew adjustment circuit 207.

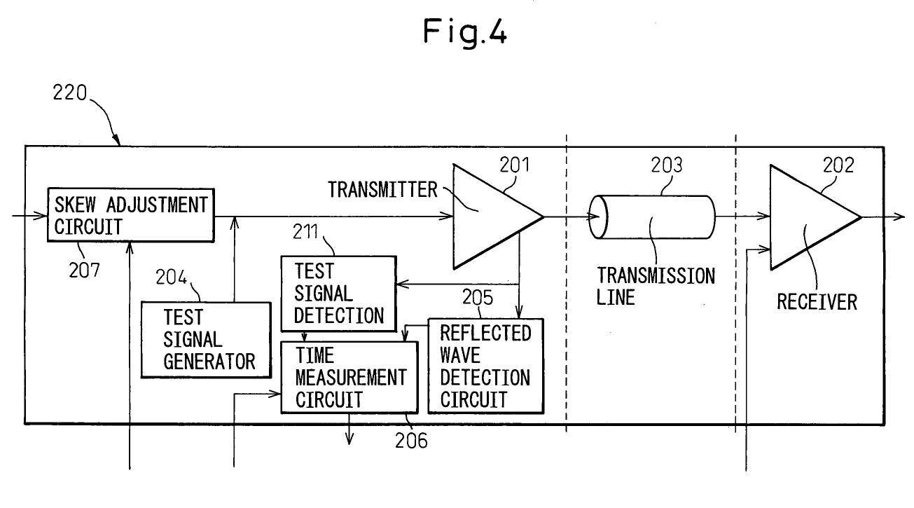

FIG. 4 shows a variant of the transmission apparatus in accordance with the embodiment of the present invention. The same reference numerals are assigned to components identical to those of the circuit shown in FIG. 1.

In the transmission apparatus shown in FIG. 1, the test signal generator 204 informs the time measurement circuit 206 of the timing of starting a time measurement. In FIG. 4, the timing of starting a time measurement is the timing that the test signal detection circuit 211 detects a change in a current wave or a voltage wave sent from the transmitter 201. Detection of a reflected wave is identical to that in the transmission apparatus shown in FIG. 1. Specifically, the reflected wave detection circuit 205 detects a change in a current wave or a voltage wave sent from the transmitter 201, and ends the time measurement. In this case, unlike the detection performed in the transmission apparatus shown in FIG. 1, a delay caused by the transmitter is not measured but a delay caused by the transmission line alone can be detected. At this time, the test signal detection circuit 211 and reflected wave detection circuit 205 work by detecting a change in a current wave or a voltage wave, which is sent from the transmitter 201, occurring at the same node. Therefore, the test signal detection circuit 211 and reflected wave detection circuit 205 may be integrated into one circuit.

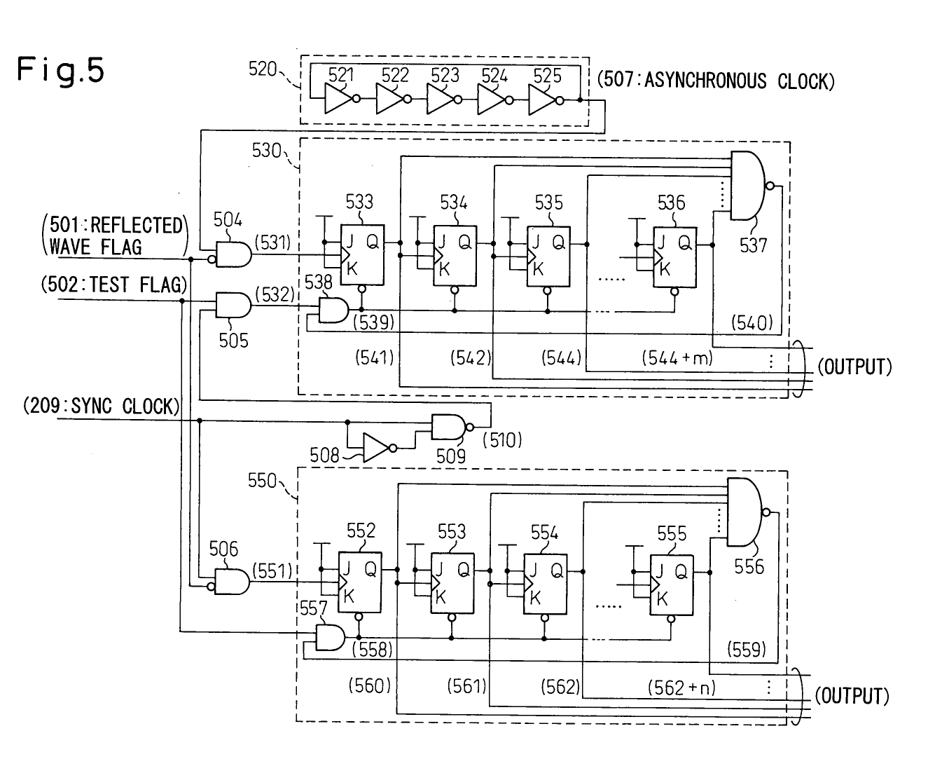

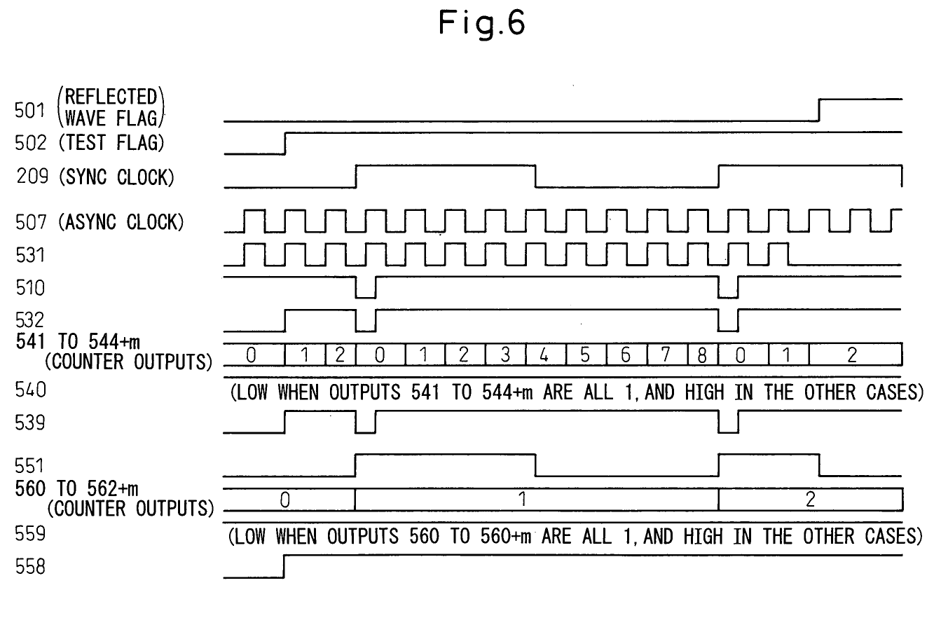

Referring to FIG. 5 to FIG. 8, the internal configurations of the time measurement circuit 206 and reflected wave detection circuit 205 included in the present embodiment will be described below. To begin with, the time measurement circuit 206 will be described with reference to FIG. 5 and FIG. 6.

FIG. 5 shows the internal configuration of the time measurement circuit 206. The time measurement circuit 206 includes a first counter 530 and a second counter 550. Time measurement starts based on a test signal generation flag 502 indicating that a test signal is generated by the test signal generator 204, and ends when the reflected wave detection circuit 205 transfers a reflected wave detection flag 501.

A clock generator 520 is composed of inverters 521 to 525. The first counter 530 counts the number of asynchronous clocks 507 generated by the clock generator 520, which is shorter than the cycle of a sync clock 209 to be used to achieve synchronization in the system, in order to measure a time. The second counter 550 counts the number of the sync clocks 209, so as to measure a time. The first counter 530 counts the asynchronous clocks in one cycle of the sync clocks 29 counted by the second counter 550.

The first counter 530 comprises J-K flip-flops 533 to 536 and OR circuits 537 and 538. The first counter 530 measures the time from the instant the test signal generation flag 502 changes its state to the instant the reflected wave detection flag 501 changes its state by counting the number of the clocks 507. When the outputs of all the J-K flip-flops 533 to 536 go high or at the timing at which the test signal generating flag 502 goes high and the sync clock 209 rises, the first counter 530 is reset. In other words, only when the reflected wave detection flag 501 is low, can the counter 530 count the clocks.

The second counter 550 comprises J-K flip-flops 552 to 555 and OR circuits 556 and 557. The second counter 550 measures the time from the instant the test signal production flag 502 changes its state to the instant the reflected wave detection flag 501 changes its state by counting the number of times the cycle of the sync clock 209 is repeated. When the outputs of all the J-K flip-flops 552 to 555 go high or when the test signal generation flag 502 goes low, the counter 530 is reset. Only when the reflected wave flag 501 is low, can the counter 550 count the clocks.

FIG. 6 is a timing chart indicating, in detail, the timings of signals. Herein, actions to be performed by the first counter 550 will be discussed. The second counter acts in the same manner as the first counter, and the actions of the second counter will be omitted.

The asynchronous clocks 507, which is counted by the first counter, is asynchronous with the sync clock 209, which is used to attain synchronization in the system, and has a shorter cycle. The first counter (or second counter) starts counting of the number of the asynchronous clocks 507, at the rising edge of the test signal generation flag 502, and ends the counting at the rising edge of the reflected wave detection flag 501.

A signal 531 which is transferred to the J-K flip-flop 533 is generated as an output of an AND circuit 504 having received the asynchronous clock 507 and reflected wave detection flag 501. The signal 531 has the same cycle as the asynchronous clock 507 when the reflected wave detection flag 501 is held low.

Moreover, an enable signal 539 that is input to the J-K flip-flop 533 is produced as the AND signal of a signal 532 and a signal 540 sent from the OR circuit 537. The signal 532 is produced as the AND signal of a signal 510 and the test signal generating flag 502. The signal 510 is produced as the NAND signal of the sync clock 209 and the reverse of the sync clock 209 from an inverter 508. The signal 510 is normally high, goes low at the rising edge of the sync clock 209, and remains low during a period equivalent to a delay caused by the inverter. The signal 532 remains high only when the test signal generation flag 502 is high and the signal 510 is high. Referring to the timing chart, the enable signal 539 is identical to the signal 532. The number of the signals 531 or asynchronous clocks 507 is counted when the signal 532 is high.

Outputs 541 to 541+m from the first counter 530 are numerical values indicating the counted number of the asynchronous clocks 507 between the adjoining rising edges of the sync clock 209.

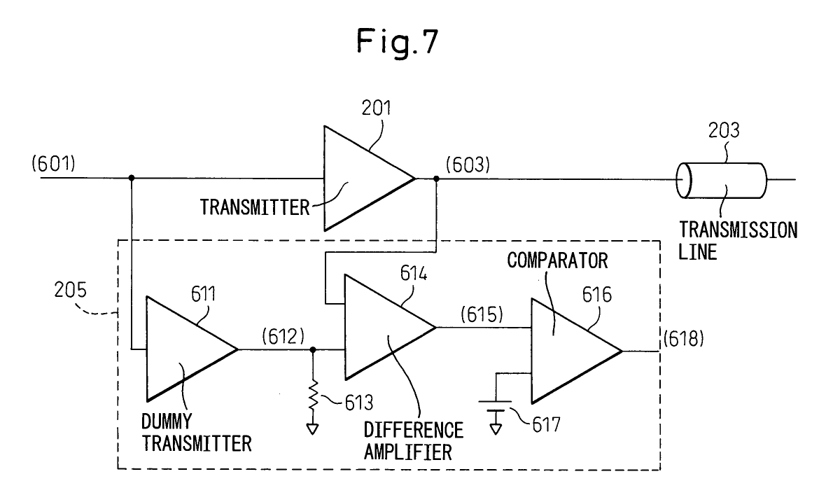

FIG. 7 shows an example of the reflected wave detection circuit 205 included in the embodiment of the present invention. The reflected wave detection circuit 205 detects, as mentioned above, a reflected wave, of a signal, which is reflected from the receiving terminal of the receiver, at the transmitting terminal of the transmitter.

A test signal 601 is a signal having an edge and being sent from the test signal generator 204. During detection of a skew, the transmitter 201 transmits the test signal 601 over the transmission line 203. When the test signal 601 is transmitted, a high-impedance termination signal is transferred to the receiver (not shown) and the receiving terminal of the receiver therefore offers a high impedance.

The reflected wave detection circuit 205 comprises a dummy transmitter 611, a matched terminal resistor 613, a difference amplifier 614, a comparator 616, and a reference voltage source 617. The matched terminal resistor 613 is a resistor whose impedance is matched with the impedance characteristic of the dummy transmitter 611. The dummy transmitter 611 produces a dummy signal 612 from the test signal 601. In this example, the dummy signal 612 is identical to a signal to be transmitted by the transmitter 602. The dummy signal 612 is transferred to the matched terminal resistor 613 and also applied to one of the input terminals of the difference amplifier 614. A detection signal 603 detected at the terminal of the transmitter (that is a transmission signal) is applied to the other input terminal of the difference amplifier 614. The difference amplifier 614 amplifies a voltage difference between the dummy signal 612 produced by the dummy transmitter 611 and the detection signal 603 so as to produce an amplified difference signal 615.

A reflected wave exists in a signal transmitted from the transmitter 201. The amplified difference signal represents a certain difference until the reflected wave is returned. The amplified difference signal 615 is applied to one of the input terminals of the comparator 616, and the reference voltage 617 is applied to the other input terminal of the comparator 616. The reference voltage 617 serves as a threshold for detection of a reflected wave whose production depends on the relationship between the dummy signal 612 and detection signal 603 and the amplification factor of the difference amplifier 614. The comparator 616 compares the amplified difference signal 615 with the reference voltage 617 so as to check if the amplified difference signal 615 is larger or smaller than the reference voltage 617. The comparator 616 then produces a reflected wave detection flag. The reference voltage 617 prevents malfunction deriving from noise. The reflected wave detection flag 618 is transferred to the time measurement circuit and starts a time measurement. In this example, the dummy signal is used to compare with the transmission signal, that is, the detection signal. Consequently, sensitivity in detection improves. The dummy signal is not always identical to the transmission signal but may be a signal that is a function of the transmission signal or correlates with the transmission signal.

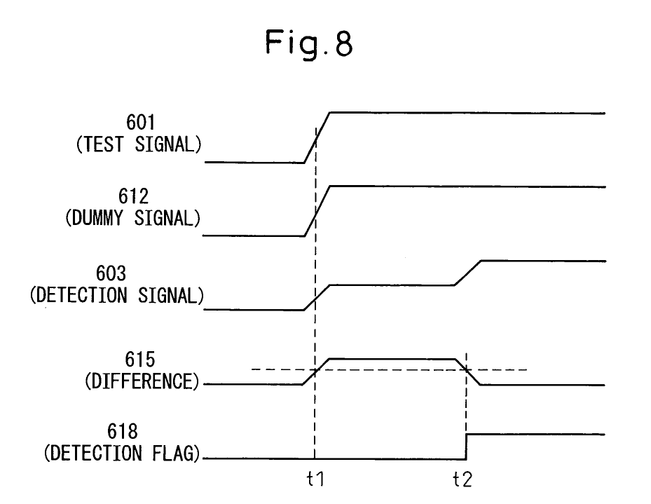

FIG. 8 shows waveforms to indicate actions to be performed by the reflected wave detection circuit. If the test signal 601 is a signal having an edge as shown in FIG. 8, in this example, the dummy signal 612 has the same waveform as the test signal. The test signal 601 and dummy signal 612 are transmitted at the same time t1. However, a voltage wave at the transmitting terminal of the transmitter, that is, the detection signal 603 requires a long time to rise to the same magnitude as a steady-state voltage because of the presence of the reflected-wave signal. Namely, the amplified difference signal 615 has a certain magnitude. When the reflected wave returns at time t2, the detection signal 603 detects a steady-state transmission signal and the amplified difference signal 615 returns to the zero level. Data representing the time t2 is transmitted as a reflected wave detection flag to the time measurement circuit. As the transmission of the test signal is detected at the time t1, a time measurement start signal to be sent from the test signal detection circuit 211 shown in FIG. 4 may be generated accordingly.

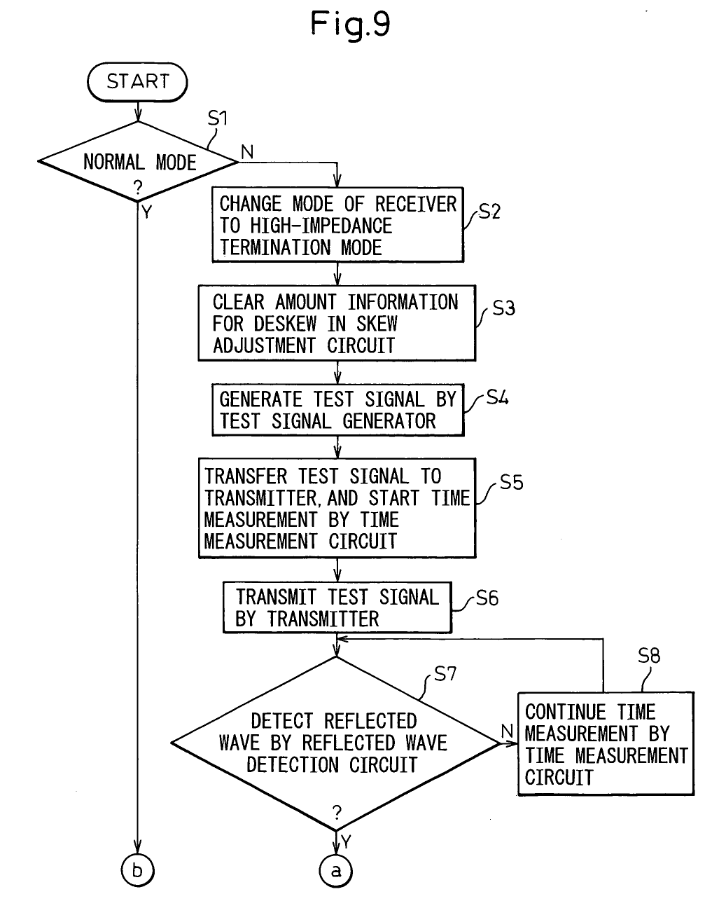

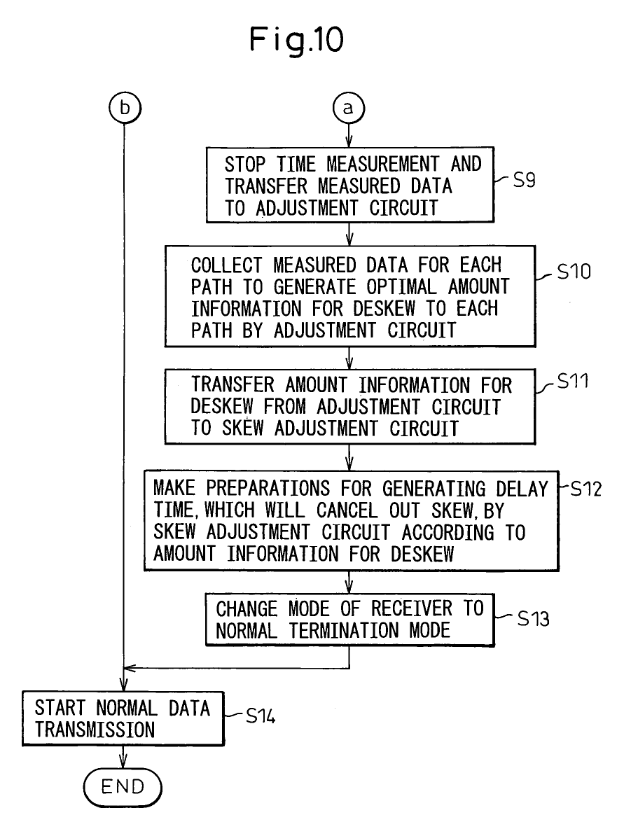

Finally, a flow of detection of an amount for deskew, to be performed in the transmission apparatus shown in FIG. 1, will be described with reference to FIG. 9 and FIG. 10. First, at step S1, whether a normal mode is designated is verified. If the normal mode is designated, processing proceeds to step S13 (FIG. 10) and normal data transmission is performed. If the normal mode is not designated but skew detection starts, processing proceeds to step S2. A high-impedance termination signal 210 is transmitted to the receiver 202 in order to change the mode of the receiver 202 to a high-impedance termination mode.

At step S3, amount information for deskew remaining in the skew adjustment circuit 207 is cleared in order to receive new amount information for deskew.

At step S4, the test signal generator 204 generates a test signal.

At step S5, the test signal is transmitted to the transmitter 201, and a test signal generation flag is transmitted to the time measurement circuit 206. The time measurement circuit 206 starts measurement of time. The test signal generation flag may not be generated by the test signal generator. Instead, a test signal detection circuit may be included for detecting an output of the transmitter 201 so as to detect the test signal. The test signal generation flag may be generated by the test signal detection circuit (FIG. 4). In this case, step S5 and step S6 are switched.

At step S6, the transmitter 201 transmits a test signal. At step S7, whether a reflected wave reflecting from the receiving terminal of the receiver is detected is verified. If the reflected wave is not detected, processing proceeds to step S8. The time measurement circuit 206 continues measurement of a time. If the reflected wave is detected, processing proceeds to step S9.

At step S9, the time measurement circuit 206 receives a reflected wave detection flag indicating that the reflected wave is detected, ends measurement of a time, and transmits measured data to the adjustment circuit 208.

At step S10, the adjustment circuit 208 collects measured data items concerning the respective transmission lines or paths, calculates optimal amount for deskew, and provides them as pieces of line-specific amount information for deskew.

At step S10, the adjustment circuit 208 transmits associated deskew information to the skew adjustment circuit 207. The pieces of amount information for deskew relating to the other paths are transmitted in the same manner (to the other circuit blocks 221).

At step S12, the skew adjustment circuit having received the new amount information for deskew makes preparations for producing a delay time, which will cancel out a skew, according to the amount information for deskew.

At step S13, the receiver is changed from the high-impedance termination mode to the normal termination mode. At step S14, normal data transmission starts.

While the invention has been described with reference to specific embodiments chosen for purpose of illustration, it should be apparent that numerous modifications could be made thereto by those skilled in the art without departing from the basic concept and scope of the invention.

1. A transmission apparatus comprising a plurality of circuit blocks each of which includes a skew adjustment circuit, a transmitter, a transmission line, and a receiver, and an adjustment circuit that produces amount information for deskew for each of the circuit blocks, wherein the skew adjustment circuit transmits a signal, which has been skew-adjusted according to the amount information for deskew produced by the adjustment circuit, to the transmitter;
said circuit block comprises:
a test signal generator that generates a test signal having an edge and transfers the test signal to the transmitter;
a reflected wave detection circuit that detects a reflected wave of the test signal; and
a time measurement circuit that measures the time from the instant the test signal is generated to the instant the reflected wave is detected; and
data representing the time measured by said time measurement circuit is transferred to said adjustment circuit.

2. The transmission apparatus according to claim 1, further comprising a high-impedance termination signal generator that generates a high-impedance termination signal to provide a high impedance at the receiving terminal of the receiver, wherein the receiving terminal has the high impedance before the transmission of the test signal receiver.

3. The transmission apparatus according to claim 1, wherein said test signal having an edge is a single pulse.

4. The transmission apparatus according to claim 1, wherein said reflected-wave detection circuit detects a reflected wave on the basis of a voltage change at a transmitting terminal of said transmitter.

5. The transmission apparatus according to claim 1, wherein said reflected-wave detection circuit includes a dummy signal generator that generates a dummy signal which correlates at least with said test signal, and the difference of a detected reflected wave from the dummy signal is detected in order to detect the reflected wave.

6. The transmission apparatus according to claim 5, wherein the difference between the reflected wave and the dummy signal is further compared with a reference signal.

7. The transmission apparatus according to claim 1, further comprising a test signal detection circuit that detects a signal at said transmitting terminal of said transmitter so as to detect generation of the test signal.

8. The transmission apparatus according to claim 7, wherein said reflected wave detection circuit detects the test signal to detect a signal at the transmitting terminal of the transmitter.

9. The transmission apparatus according to claim 1, wherein said time measurement circuit includes a first counter, that counts the number clocks asynchronous with a system clock, the cycle of which is shorter than the cycle of the system clock, and a second counter that counts the number of the system clocks.
